(19) United States
(12) Patent Application Publication
(10) Pub. No.: US 2003/0046873 A1
(43) Pub. Date: Mar. 13, 2003

(54) Sound-absorbing material for vehicle's lower portion

(75) Inventors: Yoshihiro Kohara, Hiroshima-shi (JP); Tatsuo Kobayashi, Hiroshima-shi (JP); Syuuji Raisu, Hiroshima-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Nishikawa Rubber Co., Ltd., Hiroshima-shi (JP)

(21) Appl. No.: 10/147,750

(22) Filed: May 17, 2002

(30) Foreign Application Priority Data
Sep. 10, 2001 (JP) 2001-273455

(51) Int. Cl. E06B 7/16

(52) U.S. Cl. 49/484.1

(57) ABSTRACT

A sound-absorbing material is attached to the bottom edge of a periphery of the lower portion of a car door 30. The material is positioned above the seal member 1 which makes a resilient contact with a body panel 20, and carries out the seal between the outside and the inside of the car. The material is made of a foam 10 having specific gravity of about 0.05-0.4. The material restrains the noise. The foam 10 may be provided with a plurality of protrusions 12 on the surface thereof, or it may be provided with a hollow part 13 along the longitudinal direction thereof.

### BACKGROUND OF THE INVENTION

This invention relates to a sound-absorbing material attached to the lower portion of a car door.

As illustrated in FIGS. 6 and 7, there has been provided a seal member 1 at the bottom edge of a perimeter of the lower portion of the car door 30, which makes a resilient contact with the body panel 20 and carries out the seal between the outside and inside of the car. A number of seal members attached to the body panel 20 is not restricted to one: there is a type which is attached to the upper inside of the seal member 1, or a type which is attached to the body panel 20 side of the seal member 1. (Such types are indicated as the seal member 2 and 3 in FIG. 7). FIG. 7 is an enlarged vertical section view along line A-A in FIG. 6.

According to this conventional seal member, it is difficult to fully control the penetration noise penetrating from the outside to the inside of the car, only by providing the above-mentioned seal members 1, 2 and 3, because there is a space between a door 30 and the body panel 20. (The penetration noise includes the noise such as music produced inside the car and penetrates to the outside.)

An object of the present invention, therefore, is to provide a sound-absorbing material for a vehicle's lower portion, which can control effectively the noise penetrating from the outside to the inside of the car or vise versa.

### SUMMARY OF THE INVENTION

In order to achieve the aforementioned object, the first aspect of the invention, the sound-absorbing material, is characterized by being attached to the bottom edge of a periphery of the lower portion of a car door (30). The material is positioned above the seal member (1) which makes a resilient contact with a body panel (20), and carries out the seal between the outside and the inside of the car. The material is made of a foam (10) having specific gravity of about 0.05-0.4. The material restrains the noise.

The second aspect of the invention is characterized by being attached to the bottom edge of a periphery of the lower portion of a car door (30). The material is positioned above the seal member which makes a resilient contact with a body panel (20) and carries out the seal between the inside and the outside of the car. The material comprises a sound absorption layer made of a foam (10) having specific gravity of 0.05-0.4, and a noise insulation layer (11) having specific gravity of 0.4 or morel. The material restrains the noise.

The third aspect of the invention is characterized by that the sound-absorbing material according to the first or second aspect of the invention is formed not to make a resilient contact with the body panel (20) while the door is closed.

The fourth aspect of the invention is characterized by that the sound-absorbing material according to the first, second or third aspect of the invention is comprised of a plurality of protrusions (12) on the surface thereof.

The fifth aspect of the invention is characterized by that the sound-absorbing material for a vehide's lower portion according to the first, second, third or fourth aspect of the invention is comprised of a hollow part (13) along the longitudinal direction thereof.

The numerals in the aforesaid parenthesis corresponds to the numerals indicated in the drawings and the preferred embodiment of the invention mentioned later.

According to the first aspect of the invention, the sound-absorbing material is equipped above the seal member which carries out the seal between the outside and the inside of the car, so that the space between a door and a body panel becomes smaller, and the noise transmitting through the space decreases.

And, since the sound-absorbing material is made of a foam having specific gravity of about 0.05-0.4, the noise transmitting through the space is restrained.

According to the second aspect of the invention, the sound-absorbing material for a vehide's lower portion is comprised of a noise insulation layer in addition to a sound absorption layer, so that the noise is restrained more effectively.

According to the third aspect of the invention, the sound absorbing-material for a vehicle's lower portion is formed not to make a direct resilient contact with the body panel while the door is closed, therefore it can prevent that a reaction force of the foam joins the seal member by the resilient contact, and that a door closing performance worsens.

According to the fourth and fifth aspects of the invention, the sound-absorbing material for a vehide's lower portion is comprised of a plurality of protrusions on the surface thereof, or it is comprised of a hollow part, so that the surface of the material widens as compared with one having a smooth surface, and the sound absorption effect of the sound-absorbing material improves.

### BRIEF DESCRIPTION OF THE DRAWINGS

FIG. 1 is a vertical section view along line A-A in FIG. 6, which illustrates a condition where an embodiment of the sound-absorbing material for a vehicle's lower portion according to the present invention is attached to a car.

FIG. 2 is a perspective view showing the wearing methods of the preferred embodiment of the sound-absorbing material for a vehicle's lower portion according to the present invention.

FIG. 3 is a perspective view showing another embodiment of the sound-absorbing material for a vehide's lower portion of the present invention.

FIG. 4 is a sectional view showing another embodiment of the sound-absorbing material for a vehicle's lower portion according to the present invention.

FIG. 5 is a sectional view showing another embodiment of the sound-absorbing material for a vehicle's lower portion according to the present invention.

FIG. 6 is an appearance side view of a car.

FIG. 7 is an enlarged section view along line A-A in FIG. 6, showing the composition of a vehicle lower part as a conventional example.

### DETAILED DESCRIPTION OF THE PREFERRED EMBODIMENTS

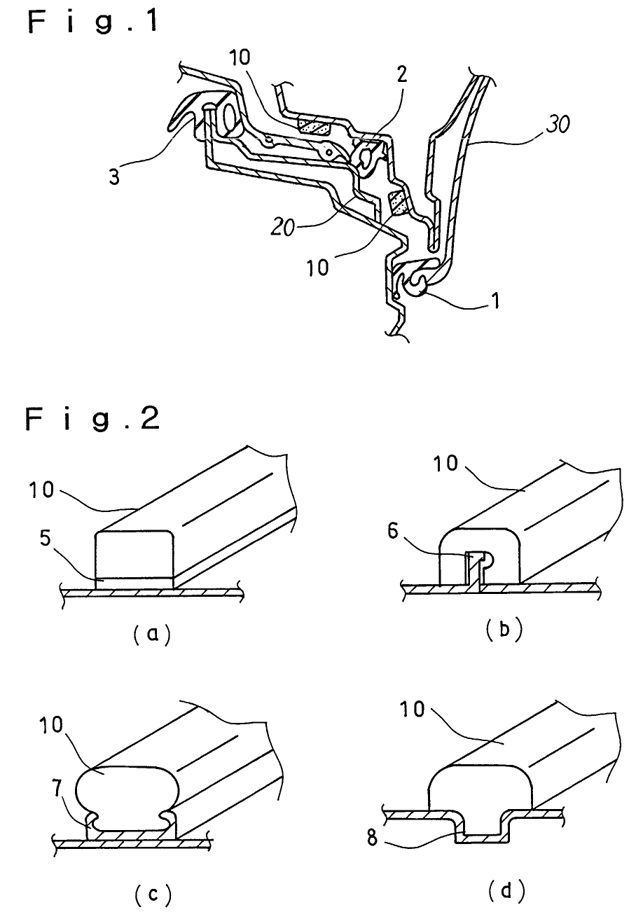

A preferred embodiment of the present invention will be described below referring to the drawings. The same numerals are given to the identical portions as the conventional example. FIG. 1 is a vertical section view along line A-A in FIG. 6, which illustrates an embodiment of a sound-absorbing material for a vehicle's lower portion according to the present invention which is attached to a car.

As shown in FIG. 1, the seal member 1 is attached to the bottom edge of a periphery of the lower part of the car door 30, making a resilient contact with the body panel 20 while the door is closed. The seal member 1 makes the seal between the inside and the outside of the car.

At an inner upper side of the seal member 1, another seal member 2 is attached, making also a resilient contact with the body panel 20 while the door closed. Furthermore, another seal member 3 is attached to the body panel 20 side.

There are provided two pieces of foams 10 at the lower part of the door above the seal member 1. Particularly, one is attached between the seal members 1 and 2, and the other at an inner upper side of the seal member 2. (Although, two pieces of foams 10 are provided in this embodiment, it is also sufficient to provide one piece or three pieces or more.) This foam 10 is formed to effectively restrain the noise penetrating from the inside to the outside of the car, or contrary, from the outside to the inside. The foam 10 is equipped approximately parallel to the door surface like the seal members 1 and 2.

As shown in FIG. 2(a), the foam 10 may be equipped through the aid of the adhesion material 5 attached in the bottom of the foam 10, or as shown in FIGS. 2(b), (c), it may be fitted to the flange 6 or rail 7 formed in the door panel. Further, as shown in FIG. 2(d), the foam 10 may be fitted into the recess 8 which is formed by transforming the door panel.

The foam 10 has specific gravity of about 0.05-0.4, and it is equipped to the body panel 20 providing a space between the foam 10 and the body panel 20 while the door is closed, so that foam 10 does not make a resilient contact with the body panel 20.

The space is provided to enable a light door dosing performance. If the foam 10 makes a resilient contact with the body panel 20, a reaction force of the foam 10 joins the reaction force of the seal members 1 and 2, and makes a door closing performance uneasy. The space prevents such trouble. It is ideal to make the space zero (zero touch setup) between the foam 10 and the body panel 20 in order to lessens the noise. (The “zero touch setup” means a condition where the foam 10 nearly touches the body panel 20.) However, when doors' variations in accuracy of fittings are considered, it is better to provide some space. (Of course, if there is no variations, a zero touch setup can be considered.)

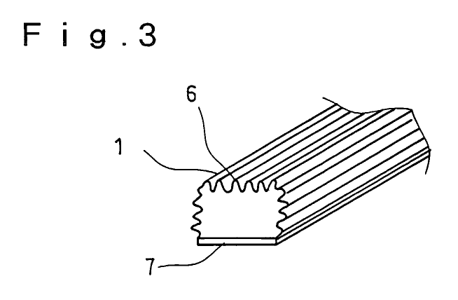

As shown in FIG. 2, the foam 10 may be provided with a smooth surface, or, as shown in FIG. 3, it may be provided with a plurality of protrusions 12 on the surface thereof. By providing a plurality of protrusions 12, the surface area of the foam 10 widens as compared with one having a smooth surface, thus, the sound absorption effect improves. The protrusions 12 can be made with a various mode by changing the height and contiguity interval between each protrusion.

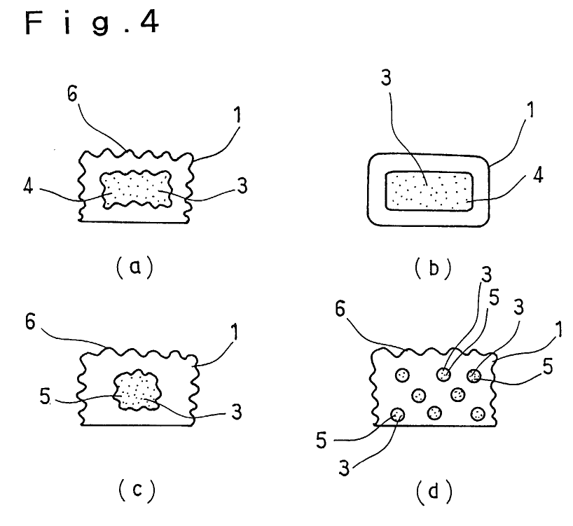

Further, as shown in FIG. 4, the hollow part 13 may be made in the foam 10 along its longitudinal direction. By providing the hollow part 13, the surface area also widens compared to the one having a smooth surface like the protrusions 12 described above, and the sound absorption effect improves. Especially, the energy of the noise that entered into the hollow part 13 is attenuated by the internal air layer. As shown in FIGS. 4(a), (b), and (c), the hollow part 13 has various types of forms, and as shown in FIG. 4(d), it may be provided with a plural number of hollow parts 13.

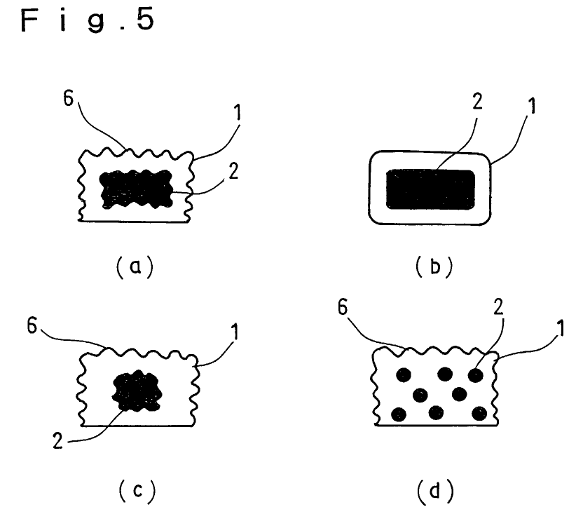

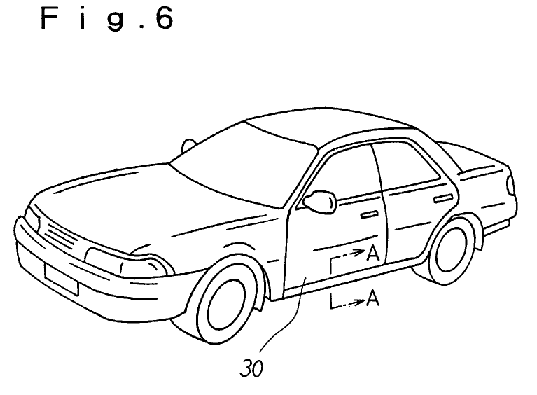

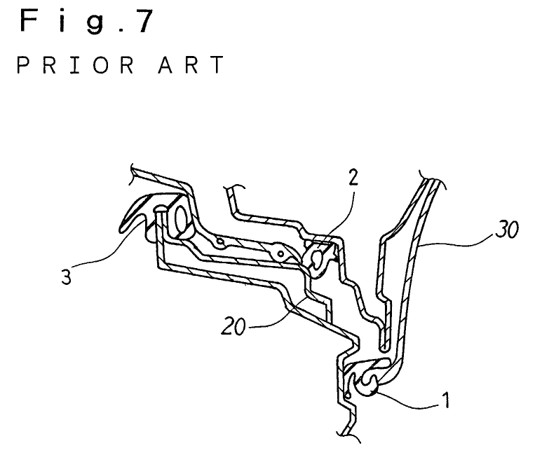

Furthermore, as shown in FIG. 5, a noise insulation layer 11 having specific gravity of 0.4 or more may be added and multilayered to a sound absorption layer having specific gravity of 0.05-0.4, so that it restrains the noise from the point of both the sound absorption effect and the noise insulation effect.

This preferred embodiment of the invention exhibits the sound-absorbing material which is attached to the door side, but the same sound absorption effect is acquired even if it is attached to the body side.

As described hereinbefore, according to the preferred embodiment of the invention, the sound-absorbing material for a vehicle's lower portion is equipped above the seal member which carries out the seal between the inside and the outside of the car, so that the space between the door and the body panel becomes smaller, and the noise penetrating through the space decreases. And, since the sound-absorbing material is made of a foam having specific gravity of about 0.05-0.4, the noise penetrating through the space is restrained.

Therefore, the amenity inside the car improves by restraining the penetration of noise from outside, while the noise such as music produced inside the car is prevented from leaking to the outside.

And, according to the preferred embodiment of the invention, the noise insulation layer is provided in addition to the sound absorption layer, so that it can restrain the noise much more effectively.

Further, according to the preferred embodiment of the invention, the sound-absorbing material for a vehicle's lower portion is formed not to make a resilient contact with the body panel in a door dosed position, therefore, it can prevent that the reaction force of the foam joins the seal member, and that a door closing performance worsens.

Furthermore, according to the preferred embodiment of the invention, the sound-absorbing material is comprised of a plurality of protrusions on the surface thereof, or it is comprised of a hollow part, so that the surface area widens as compared with one having a smooth surface, and that the sound absorption effect improves.

What is claimed is:

1. A sound-absorbing material for a vehicle's lower portion characterized by being attached to the bottom edge of a periphery of the lower portion of a car door, said material being equipped above the seal member which makes a resilient contact with a body panel and carries out the seal between the inside and the outside of the car, said material being made of a foam having specific gravity of about 0.05-0.4, and said material being able to restrain the noise.

2. A sound-absorbing material for a vehide's lower portion characterized by being attached to the bottom edge of a periphery of the lower portion of a car door, said material being equipped above the seal member which makes a resilient contact with a body panel and carries out the seal between the inside and the outside of the car, said material comprising a sound absorption layer made of a foam having specific gravity of 0.05-0.4, and a noise insulation layer having specific gravity of 0.4 or morel, and said material being able to restrain the noise.

3. A sound-absorbing material for a vehide's lower portion claimed in claim 1 or 2, wherein said material being formed to make no contacts with the door panel while the door is closed.

4. A sound-absorbing material for a vehicle's lower portion claimed in claim 1, 2 or 3, wherein said material comprising a plurality of protrusions on the surface thereof.

5. A sound-absorbing material for a vehicle's lower portion claimed in claim 1, 2, 3 or 4, wherein said material comprising a hollow part along the longitudinal direction thereof.
